(19) United States
(12) Patent Application Publication
(10) Pub. No.: US 2024/0414688 A1
(43) Pub. Date: Dec. 12, 2024

(54) NETWORK NODE, WIRELESS COMMUNICATION SYSTEM, AND USER TERMINAL

(71) Applicant: TOYOTA JIDOSHA KABUSHIKI KAISHA, Toyota-shi (JP)

(72) Inventors: Naoya KANEKO, Tokyo (JP); Xiao SHAO, Kawasaki-shi (JP); Kazuya OKADA, Tokyo (JP); Jing MA, Yokohama-shi (JP); Takuya ASAOKA, Tokyo (JP)

(73) Assignee: TOYOTA JIDOSHA KABUSHIKI KAISHA, Toyota-shi (JP)

(21) Appl. No.: 18/658,417

(22) Filed: May 8, 2024

(30) Foreign Application Priority Data
Jun. 6, 2023 (JP) 2023-093387

(51) Int. Cl. H04W 64/00; H04W 8/22; H04W 24/10

(52) U.S. Cl. CPC H04W 64/006; H04W 8/22; H04W 24/10

(57) ABSTRACT

A network node that constitutes a wireless communication network includes one or more processors configured to: receive a sensing configuration parameter for each user terminal from a plurality of user terminals; receive a sensing requirement from a first user terminal; and transmit information about a second user terminal with the sensing configuration parameter that matches the sensing requirement to the first user terminal.

### CROSS-REFERENCE TO RELATED APPLICATION

This application claims priority to Japanese Patent Application No. 2023-093387 filed on Jun. 6, 2023, incorporated herein by reference in its entirety.

### BACKGROUND

### 1. Technical Field

The present disclosure relates to a network node, a wireless communication system, and a user terminal.

### 2. Description of Related Art

Japanese Unexamined Patent Application Publication No. 2019-79453 (JP 2019-79453 A) discloses an information generation system including a plurality of sensors provided on the roadside and in a vehicle, and an information generation device. In this system, a server selects at least one piece of sensor information from among a plurality of pieces of sensor information that indicate the results of a plurality of sensors detecting an identical object based on a dynamically changeable priority order of the sensor information, and generates predetermined information based on the selected at least one piece of sensor information.

### SUMMARY

The present disclosure provides a technology that enables proxy sensing by other user terminals to be performed effectively and in a short time.

A first aspect of the present disclosure provides a network node that constitutes a wireless communication network, including one or more processors configured to: receive a sensing configuration parameter for each user terminal from a plurality of user terminals; receive a sensing requirement from a first user terminal; and transmit information about a second user terminal with a sensing configuration parameter that matches the sensing requirement to the first user terminal.

A second aspect of the present disclosure provides a wireless communication system including a first user terminal, a second user terminal, and a network node.

The second user terminal is configured to transmit a sensing configuration parameter to the network node; the network node is configured to receive the sensing configuration parameter from the second user terminal; the first user terminal is configured to transmit a sensing requirement to the network node; the network node is configured to receive the sensing requirement from the first user terminal; and the network node is configured to transmit information about the second user terminal to the first user terminal, or transmit a sensing request to the second user terminal, when the second user terminal includes a sensing configuration parameter that matches the sensing requirement.

A third aspect of the present disclosure provides a user terminal including a sensor and one or more processors.

The user terminal is a first user terminal; and the one or more processors are configured to broadcast a sensing configuration parameter for the sensor, receive a sensing configuration parameter from a second user terminal, transmit a sensing request to the second user terminal, and receive a sensing measurement result based on the sensing request from the second user terminal.

According to an aspect of the present disclosure, it is possible to enable proxy sensing by other user terminals to be performed effectively and in a short time.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIGS. 1A and 1B illustrate an overview of an embodiment of the present disclosure;

FIG. 2 illustrates constituent elements of a wireless communication system;

FIG. 3A illustrates an example of the configuration of an information processing device that is operable as a network function (NF), an operations, administration, and maintenance (OAM) terminal, and an external server;

FIG. 3B illustrates an example of the configuration of an information processing device that is operable as a user terminal;

FIG. 4 is a sequence diagram illustrating a sensing capability notification process according to a first embodiment;

FIG. 5A is a sequence diagram illustrating a cooperative sensing process according to the first embodiment;

FIG. 5B is a sequence diagram illustrating the cooperative sensing process according to the first embodiment;

FIG. 5C is a sequence diagram illustrating the cooperative sensing process according to the first embodiment;

FIG. 6 is a sequence diagram illustrating a sensing data format conversion process according to the first embodiment;

FIG. 7A is a sequence diagram illustrating a cooperative sensing process according to a second embodiment; and

FIG. 7B is a sequence diagram illustrating the cooperative sensing process according to the second embodiment.

### DETAILED DESCRIPTION OF EMBODIMENTS

### Overview

There is known cooperative sensing in which sensing results from a plurality of user terminals are integrated to obtain a single sensing result. There is also known proxy sensing in which a certain user terminal requests a different user terminal for sensing for a range for which the certain user terminal cannot perform sensing itself. In order to use the results of sensing by a different terminal in this manner, it is necessary to select a user terminal as a cooperation partner or a request partner appropriately and in a short time.

A first aspect of the present disclosure provides a network node that constitutes a wireless communication network, including one or more processors configured to: receive a sensing configuration parameter for each user terminal from a plurality of user terminals; receive a sensing requirement from a first user terminal; and transmit information about a second user terminal with a sensing configuration parameter that matches the sensing requirement to the first user terminal.

With such a configuration, the network node receives a sensing configuration parameter from a plurality of user terminals, and thus can select a second user terminal with a sensing configuration parameter that matches a sensing requirement from a first user terminal and notify the first user terminal of the second user terminal. Consequently, the first user terminal can be notified of a user terminal to be requested for sensing appropriately and in a short time.

The sensing configuration parameter may also be referred to as a sensing configuration, a measurement configuration parameter, and a measurement configuration.

In the network node according to the first aspect of the present disclosure, the sensing configuration parameter may be a parameter associated with a sensing capability of a user terminal. The sensing configuration parameter may be information associated with what sensing can be executed by the user terminal. In this sense, the sensing configuration parameter may also be referred to as a sensing capability and a measurement capability. In the network node according to the first aspect of the present disclosure, the sensing configuration parameter may include at least one of a frequency band to be used for sensing, a type of sensing, a position of a user terminal, a moving speed of a user terminal, a sensing target range, a precision of sensing, and a response time of sensing.

The sensing requirement may also be referred to as a measurement requirement. The sensing requirement may include a requirement that the first user terminal requires for sensing by a different user terminal. The sensing requirement may include at least one of a type of sensing, a sensing target range, a precision of sensing, and a response time of sensing, for example.

In the network node according to the first aspect of the present disclosure, the one or more processors may be further configured to: receive a measurement request for the second user terminal from the first user terminal; transmit a sensing request to the second user terminal; receive a sensing measurement result from the second user terminal; and transmit the sensing measurement result to the first user terminal.

When the network node mediates the transmission of the sensing measurement result from the second user terminal to the first user terminal in this manner, the first user terminal can request the second user terminal for sensing, even when the first user terminal and the second user terminal cannot directly communicate with each other. The sensing measurement result may be transmitted via the network node even when the first user terminal and the second user terminal can directly communicate with each other. In another embodiment, the second user terminal may transmit the sensing measurement result directly to the first user terminal. In still another embodiment, the second user terminal may transmit the sensing measurement result to the first user terminal via a node that is different from the network node.

In the network node according to the first aspect of the present disclosure, the one or more processors may be configured to transmit the sensing measurement result received from the second user terminal to the first user terminal after converting a format of the sensing measurement result based on information associated with a predetermined data format. The “predetermined data format” may be a data format that can be handled by the second user terminal or a data format desired by the second user terminal.

With such a configuration, the first user terminal can receive the sensing measurement data in a desired data format even when the data format that can be handled by the first user terminal or that is desired by the first user terminal is different from the data format of the sensing measurement data provided by the second user terminal. While the data conversion may be performed by at least one of the first user terminal and the second user terminal, the processing load on the user terminals can be reduced when the data conversion is performed by the network node.

In the network node according to the first aspect of the present disclosure, the information associated with the data format of the sensing measurement result from the second user terminal may be information to be used to convert the sensing measurement result from the second user terminal into a predetermined data format; and the sensing measurement result transmitted to the first user terminal may be expressed in the predetermined data format. Here, the predetermined data format may also be referred to as a common data format, for example.

In the network node according to the first aspect of the present disclosure, the one or more processors may be further configured to: receive a measurement request for the second user terminal from the first user terminal; transmit a sensing request to the second user terminal; and receive a notification that the sensing request is accepted, refused, or withheld from the second user terminal.

In the user terminal according to the third aspect of the present disclosure, the sensing configuration parameter may be a parameter associated with a sensing capability of the sensor.

In the user terminal according to the third aspect of the present disclosure, the sensing configuration parameter may include at least one of a frequency band to be used for sensing, a type of sensing, a position of a user terminal, a moving speed of a user terminal, a sensing target range, a precision of sensing, and a response time of sensing.

In the user terminal according to the third aspect of the present disclosure, the one or more processors may be further configured to: receive the sensing request from the second user terminal; and transmit the sensing measurement result based on the sensing request to the second user terminal.

In the user terminal according to the third aspect of the present disclosure, the one or more processors may be configured to transmit a notification that the sensing request is accepted, refused, or withheld to the second user terminal in response to receiving the sensing request from the second user terminal.

Another aspect of the present disclosure may disclose an information processing method executed by a network node that constitutes a wireless communication network. The information processing method may include: receiving a sensing configuration parameter for each user terminal from a plurality of user terminals; receiving a sensing requirement from a first user terminal; and transmitting information about a second user terminal with a sensing configuration parameter that matches the sensing requirement to the first user terminal.

Examples of the wireless communication network according to the present aspect include systems that use 5G, NR, 4G, LTE, LTE-A, SUPER 3G, IMT-Advanced, and others, and next-generation systems expanded based on these. Other examples of the wireless communication network include systems that use IEEE 802.11 (Wi-Fi (registered trademark)), IEEE 802.16 (WiMAX (registered trademark)), IEEE 802.20, UWB, Bluetooth (registered trademark), and others, and next-generation systems expanded based on these. The wireless communication network may be a system constituted by combining a plurality of systems.

An example of the network node according to the present aspect is an information processing device or a computer that includes a general-purpose processor, and the above functions are provided by the general-purpose processor executing software. Another example of the network node is an information processing device or a computer that includes a processor designed for a specific purpose. The network node may include one processor, may include a plurality of processors, or may be constituted by a plurality of information processing devices or computers.

Another aspect of the present disclosure provides a wireless communication system including the network node discussed above, a first user terminal, and a second user terminal. In the present aspect, the first user terminal and the second user terminal transmit a sensing configuration parameter to the network node; the network node receives the sensing configuration parameter from the first user terminal and the second user terminal; the first user terminal transmits a sensing requirement to the network node; the network node receives the sensing requirement from the first user terminal; and the network node transmits information about the second user terminal to the first user terminal when the second user terminal matches a sensing configuration parameter that matches the sensing requirement.

Still another aspect of the present disclosure provides a user terminal including a sensor and a processor, in which the processor is configured to: broadcast a sensing configuration parameter for the sensor, receive a sensing configuration parameter from a different user terminal, transmit a sensing request to the different user terminal, and receive a sensing measurement result based on the sensing request from the different user terminal.

According to the present aspect, the user terminal exchanges a sensing configuration parameter with a different user terminal through broadcasting, which allows selecting a different user terminal to be requested for sensing by the user terminal itself appropriately and in a short time. According to the present aspect, there is advantageously no need for another node that relays communication between the user terminals.

The present disclosure further includes a computer program that causes a computer to execute the steps of the method described above, and a computer program that implements the network node or the information processing system described above using a computer. The present disclosure further includes a computer-readable medium that stores the computer program described above.

### EMBODIMENTS

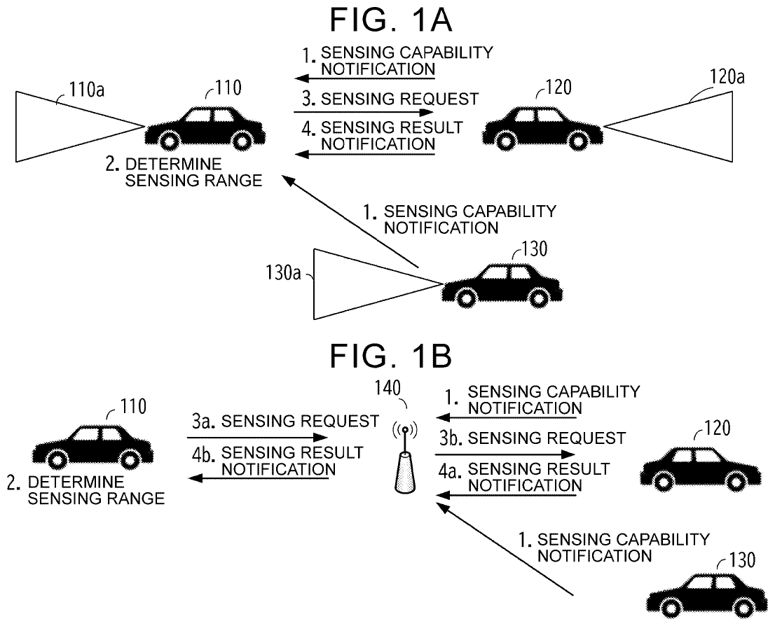

FIG. 1A illustrates an embodiment to which the present disclosure is applied. Vehicles 110, 120, and 130 are examples of a user terminal, and each include a sensor and a communication device. The sensing target ranges of the vehicles 110, 120, and 130 are denoted by symbol 110a, 120a, and 130a, respectively. Here, a situation in which the vehicle 110 desires to obtain information for a range for which the vehicle 110 cannot perform sensing itself is considered. As there is an overlap between the range 130a and the range 110a and there is no overlap between the range 120a and the range 110a, the vehicle 110 can effectively receive sensing data from the vehicle 120, rather than from the vehicle 130. That is, the vehicle 110 preferably issues a sensing request to the vehicle 120.

The present embodiment provides a unit that facilitates a determination such as the one made by the vehicle 110 as described above. Specifically, each vehicle notifies other vehicles of its own sensing capability (step 1 in FIG. 1A). The vehicle 110 determines a sensing range for which sensing data are to be obtained (step 2), determines the vehicle 120 capable of sensing for this range, and transmits a sensing request to the vehicle 120 (step 3). The sensing range is an example of a sensing requirement, and the sensing requirement is not limited to a range and may be a different requirement. The vehicle 120 executes sensing in response to the sensing request, and notifies the vehicle 110 of the results (step 4). Such a configuration allows the vehicle 110 to immediately determine which vehicle to issue a sensing request to in order to obtain desired sensing data.

While FIG. 1A indicates that the vehicles directly communicate with each other, communication among the vehicles may be relayed by a device such as a relay station and a wireless communication network.

As illustrated in FIG. 1B, a wireless communication network 140 (e.g. a network function (NF) that constitutes a 5G core network) may not only relay communication but also execute a process of determining a vehicle to be requested for sensing. This is described more specifically. Each vehicle notifies the wireless communication network 140 of its own sensing capability (step 1). The wireless communication network 140 stores the sensing capability of each vehicle. The vehicle 110 determines a sensing range for which it is desired to obtain sensing data (step 2), and transmits a sensing request that includes this range as a sensing requirement to the wireless communication network 140 (step 3a). The wireless communication network 140 determines a vehicle that can meet the sensing requirement based on sensing capability parameters that have been received, and transmits a sensing request to the determined vehicle (here, the vehicle 120). The vehicle 120 executes sensing in response to the sensing request, and notifies the vehicle 110 of the results via the wireless communication network 140 (steps 4a and 4b). Such a configuration allows requesting proxy sensing even when the vehicles cannot directly communicate with each other. The processing load on the vehicle 110 can be reduced since the wireless communication network 140 selects a vehicle that can perform sensing that matches the sensing requirement.

While a sensing request is transmitted to only one vehicle in FIGS. 1A and 1B, a sensing request may be transmitted to a plurality of vehicles to obtain sensing data from the vehicles.

### First Embodiment

An embodiment of the present disclosure will be described below with reference to the drawings. In the present embodiment, as illustrated in FIG. 1B, the wireless communication network 140 mediates a process between user terminals (e.g. vehicles).

The following embodiments are merely examples for description, and the present disclosure is not limited to the configuration of the embodiments. For example, while an example in which the present disclosure is applied to a 5th generation mobile communication system will be described below, the present disclosure may be applied to 4th generation or 6th generation or later mobile communication systems. The present disclosure may be applied to mobile communication systems prescribed by establishments other than the Third Generation Partnership Project (3GPP), and may be applied to any wireless communication system or wired communication system other than mobile communication systems.

### Configuration of Information Processing System

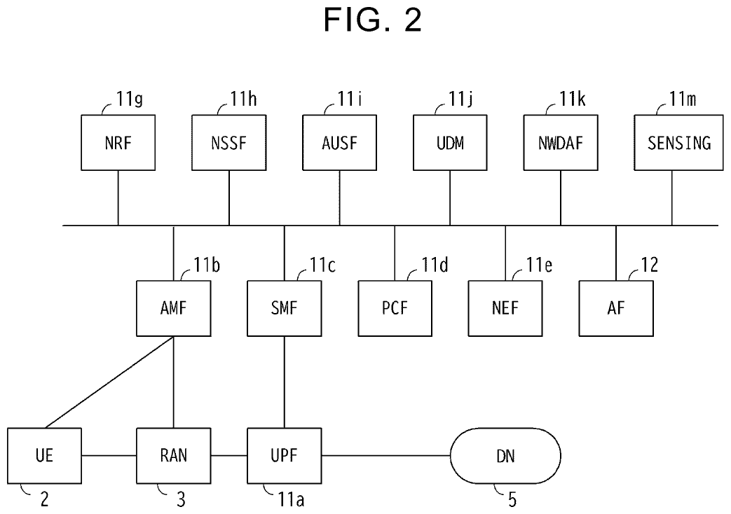

FIG. 2 illustrates components (constituent elements) that constitute a 5th generation mobile communication system (5G network). In FIG. 2, user equipment (UE) 2 is a user (subscriber) terminal. A radio access network (RAN) 3 is an access network to a 5G core network (5GC). The RAN 3 is constituted by a base station (gNB). The 5G network includes a 5G core network (5GC) and an access network ((R)AN). The UE 2, a data network (DN) 5, and an analytics function (AF) 12 are connected to the 5G network. UPF 11a to SENSING 11m as network functions (NFs) are each a function implemented by one or more computers (information processing devices) executing a program. However, a single computer may implement any two or more of the UPF 11a to the SENSING 11m as NFs. The UPF 11a to the SENSING 11m as NFs may also be referred to as network nodes or network components.

The 5GC is constituted by a collection of components that have a predetermined function called a network function (NF). FIG. 2 illustrates the following as the NFs that constitute the 5GC. The NFs are indicated by thick rectangles in FIG. 2.
User plane function (UPF) 11a
Access and mobility management function (AMF) 11b
Session management function (SMF) 11c
Policy control function (PCF) 11d
Network exposure function (NEF) 11e
Network repository function (NRF) 11g
Network slice selection function (NSSF) 11h
Authentication server function (AUSF) 11i
Unified data management (UDM) 11j
Network data analytics function (NWDAF) 11k
Sensing function (SENSING) 11m

The UPF 11a performs routing and transfer of user packets (user-plane packets transmitted and received by the UE 2), packet inspection, and QoS processing.

The AMF 11b is a location accommodation device for UE in the 5GC. The AMF 11b accommodates the RAN 3, and performs subscriber authentication, position (mobility) management for the UE 2, etc.

The SMF 11c manages a protocol data unit (PDU) session, and controls the UPF 11a in order to perform quality of service (QoS) control and policy control. The PDU session is a virtual communication path for exchange of data between the UE 2 and the data network (DN) 5. The DN 5 is a data network (such as the Internet) outside the 5GC.

The PCF 11d performs QoS control, policy control, billing control, etc. under the control of the SMF 11c. In the QoS control, the quality of control such as priority transfer of packets is performed. In the polity control, communication control such as QoS, packet transfer possibility, and billing based on network or subscriber information is performed.

The NEF 11e plays a role of mediating communication between external nodes and nodes in the control plane.

The NRF 11g stores and manages information on the NFs (e.g. AMF, SMF, UPF, etc.) in the 5GC. In response to an inquiry about an NF desired to be used, the NRF 11g can reply a plurality of candidates for the NF to the origin of the inquiry.

The NSSF 11h has a function of selecting a network slice to be used by a subscriber from among network slices generated by network slicing. The network slices are virtual networks with specifications that match their purposes.

The AUSF 11i is a subscriber authentication server that performs subscriber authentication under the control of the AMF 11b.

The UDM 11j holds information associated with subscribers, and provides subscriber information or acquires, registers, deletes, and changes the state of the UE 2.

The NWDAF 11k has a function of collecting and analyzing data from each NF, an operations, administration, and maintenance (OAM) terminal 8 (FIG. 2), an external server, etc. The NWDAF 11k is an NF that provides network analysis information.

The SENSING 11m provides a service to mediate or arbitrate proxy sensing or cooperative sensing among the UEs 2. The SENSING 11m will be discussed in detail later.

The AF 12 is an NF that provides application services via the NRF 11g as a part of the 5GC, or an NF that is external to the 5GC and that provides application services via the NEF 11e. The AF 12 performs a process using sensing data, for example. By way of example, the AF 12 converts the format of sensing measurement data obtained from the SENSING 11m. The UE 2 or an application program executed by the UE 2 may operate as the AF 12. The AF 12 that performs such operation can be regarded as a format conversion device.

In the 5GC, a plurality of NFs of the same type may be prepared. For example, the NF 11 may be prepared for each data center (station building). Alternatively, one NF 11 may be shared among the data centers. Alternatively, a plurality of NFs 11 of the same type may be constituted for one data center. The number of data centers, the number of NFs, and the correspondence between the NFs and the data centers may be set as appropriate.

The SENSING (sensing unit) 11m executes a process of at least any of receiving and storing a sensing configuration parameter or a sensing capability from the UE 2, receiving a sensing proxy request from the UE 2, selecting UE 2 that matches the sensing proxy request, transmitting a sensing request to the matching UE 2, receiving sensing measurement data from the matching UE 2 and transmitting the sensing measurement data to the requesting UE 2, and converting the format of the sensing measurement data. The SENSING 11m may also be referred to as a mediation function, a mediation device, an arbitration function, or an arbitration device for cooperative sensing or proxy sensing. The SENSING 11m or the information processing device that implements the SENSING 11m is an example of a “network node” according to the present disclosure.

### Configuration of Information Processing Device and Terminal

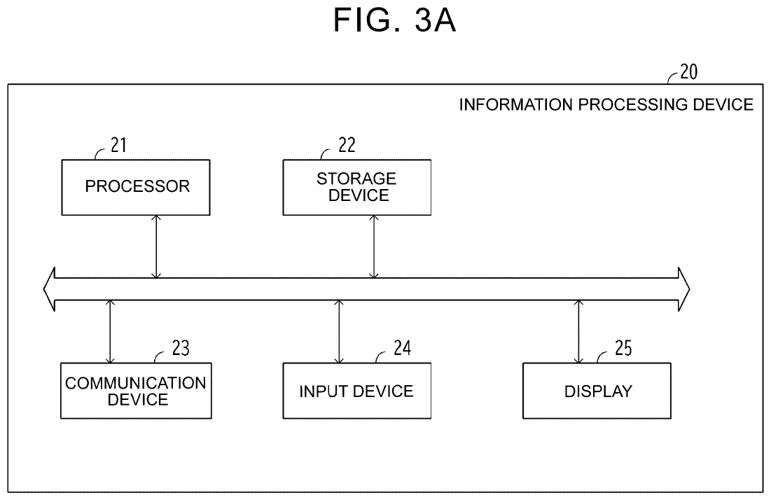

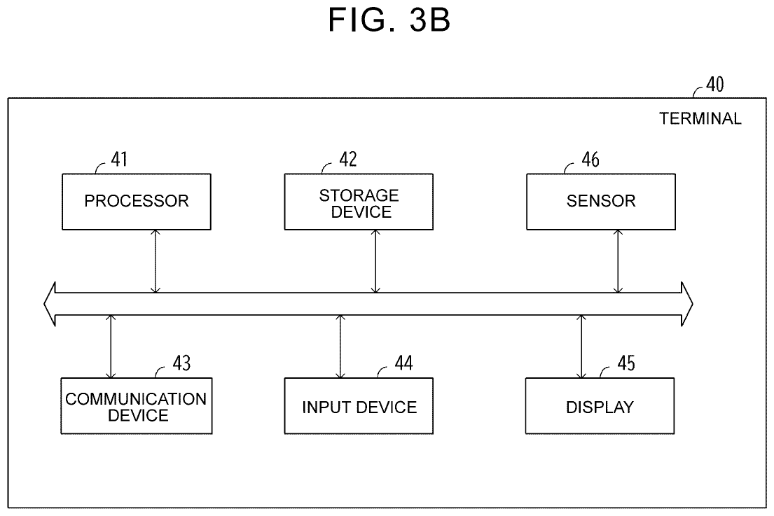

FIG. 3A illustrates an example of the configuration of an information processing device that is operable as each of the UPF 11a to the SENSING 11m as the NFs, the OAM terminal, and the external server. In FIG. 3A, an information processing device 20 can be constituted using a dedicated or general-purpose information processing device (computer) such as a personal computer (PC), a workstation (WS), or a server machine. The information processing device 20 may be a collection (cloud) of one or more computers.

The information processing device 20 includes a processor 21 as a processing unit or a control unit (controller), a storage device 22, a communication device 23, an input device 24, and a display 25, which are connected to each other via a bus.

The storage device 22 includes a main storage device and an auxiliary storage device. The main storage device is used as at least one of a storage area for programs and data, an expansion area for programs, a work area for programs, a buffer area for communication data, etc. The main storage device is constituted as a random access memory (RAM) or a combination of a RAM and a read only memory (ROM). The auxiliary storage device is used as a storage area for data and programs. A non-volatile storage medium is applied as the auxiliary storage device. Examples of the non-volatile storage medium include a hard disk, a solid state drive (SSD), a flash memory, and an electrically erasable programmable read only memory (EEPROM). The storage device 22 may include a drive device for a disk storage medium.

The communication device 23 is a circuit that performs a communication process. Examples of the communication device 23 include a network interface card (NIC). The communication device 23 may also be a wireless communication circuit that performs wireless communication (such as 5G, wireless local area network (LAN) (Wi-Fi (registered trademark)), and Bluetooth Low Energy (BLE)). The communication device 23 may be a combination of a circuit that performs a wired communication process and a wireless communication circuit.

The input device 24 includes keys, buttons, a pointing device, a touch panel, etc., and is used to input information. The display 25 may be a liquid crystal display, for example, and displays information and data.

The processor 21 performs various processes by executing the various programs stored in the storage device 22. The information processing device 20 can operate as each of the UPF 11a to the SENSING ilk as the NFs, the OAM terminal 8, and the external server when the processor 21 executes the programs stored in the storage device 22.

FIG. 3B illustrates an example of the configuration of a terminal 40 that is operable as the UE 2. The terminal 40 includes a processor 41, a storage device 42, a communication device 43, an input device 44, a display 45, and a sensor 46, which are connected to each other via a bus. The processor 41, the storage device 42, the communication device 43, the input device 44, and the display 45 may be the same as the processor 21, the storage device 22, the communication device 23, the input device 24, and the display 25, respectively. Therefore, these will not be described.

The processors 21 and 41 may be a central processing unit (CPU), for example. The CPU is also called a microprocessor unit (MPU). The processors 21 and 41 may have a single processor configuration or a multi-processor configuration. A single physical CPU connected through a single socket may have a multi-core configuration. The processors 21 and 41 may include a computation device with various circuit configurations, such as a digital signal processor (DSP) or a graphics processing unit (GPU). The processors 21 and 41 may be configured to cooperate with at least one of an integrated circuit (IC), other digital circuits, analog circuits, etc. The integrated circuit includes a large scale integration (LSI) circuit, an application specific integrated circuit (ASIC), a programmable logic device (PLD), etc. Examples of the PLD include a field-programmable gate array (FPGA). Examples of the processors 21 and 41 include a microcontroller (MCU), a system-on-a-chip (SoC), a system LSI, and a chipset.

Examples of the sensor 46 include sensors that measure the external environment of the UE 2, such as a radar sensor such as a millimeter wave radar, a light detection and ranging (LiDAR) sensor, an ultrasonic sensor, an image sensor, an acoustic sensor, a positioning sensor, an illuminance sensor, a rainfall sensor, a temperature sensor, and a humidity sensor. Other examples of the sensor 46 include a speed sensor, an acceleration sensor, and sensor that measure the internal state of the UE 2. The sensors mentioned here are merely exemplary, and the present disclosure may include any sensor. Operation Example: Notification of Sensing Capability

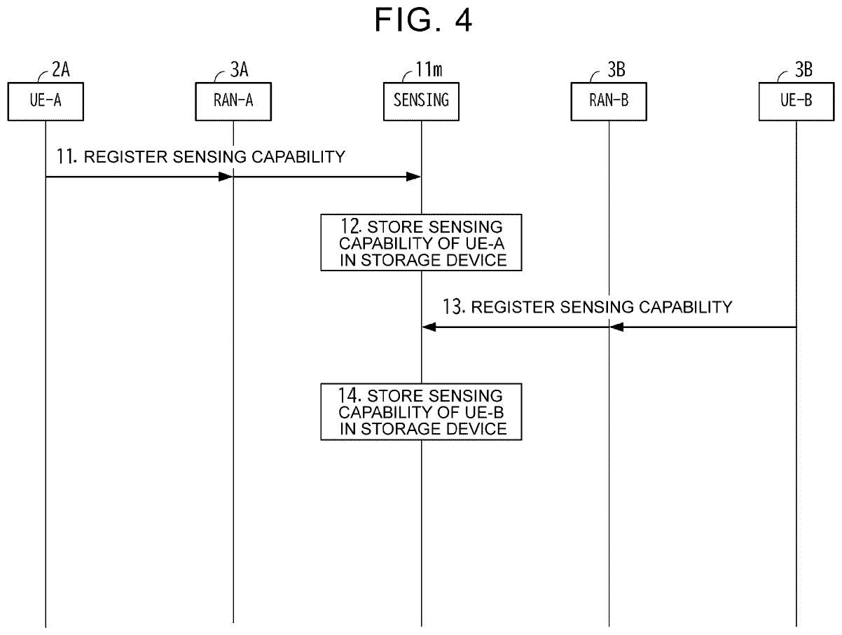

FIG. 4 is a sequence diagram illustrating a process for the UE 2 to make a notification of a sensing capability (sensing configuration parameter) according to the present embodiment. While two UEs 2, namely UE-A (2A) and UE-B (2B), are used in the description here, the number of UEs 2 is not specifically limited. The RANs 3 that include base stations (gNBs) connected to the UE-A and the UE-B are referred to as a RAN-A (3A) and a RAN-B (3B), respectively. The UE-A can be considered as an example of a “first user terminal” according to the present disclosure, and the UE-C can be considered as an example of a “second user terminal”.

In step 11, the UE-A registers a notification including a sensing capability in the SENSING 11m via the RAN-A. The sensing capability may be at least one of the frequency band to be used for sensing, the type of sensing, the position of the user terminal, the moving speed of the user terminal, the sensing target range, the precision of sensing, and the response time of sensing, for example. The notification including a sensing capability may be referred to as a sensing capability notification, a sensing configuration notification, a measurement capability notification, a measurement configuration notification, etc.

In step 12, the SENSING 11m stores the sensing capability received from the UE-A in the storage device. In this event, the sensing capability received from the UE-A may be stored as it is in the storage device, or may be stored after data processing in the storage device.

Steps 13 and 14 are steps for storing a notification of a sensing capability from the UE-B and are the same as steps 11 and 12, respectively, and thus are not described.

### Operation Example: Execution of Cooperative Sensing

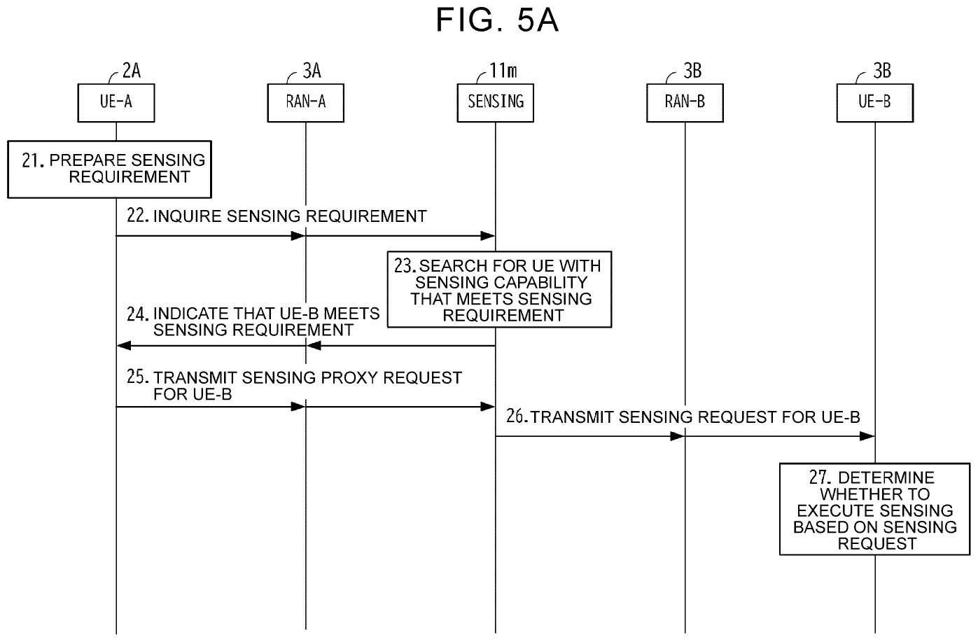

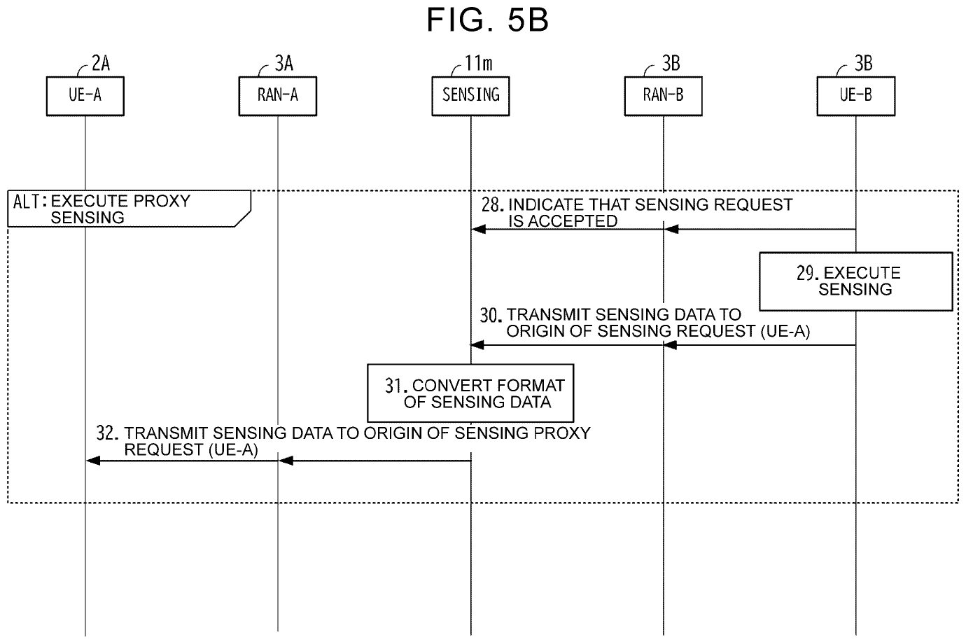

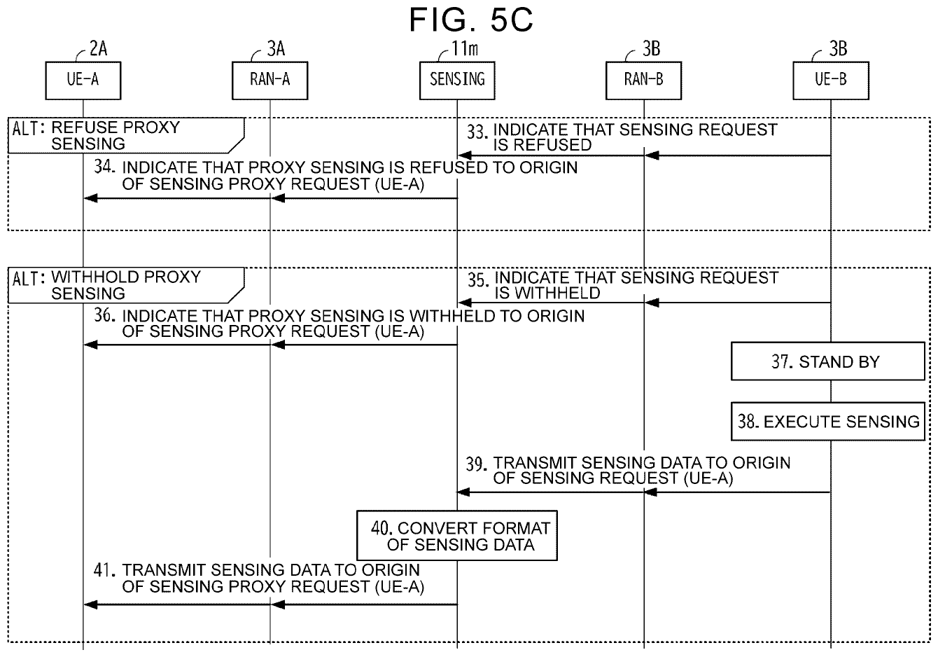

FIGS. 5A to 5C are each a sequence diagram illustrating a process in which the UE-A requests a different UE to execute sensing and acquires sensing measurement data from the different UE.

In step 21, the UE-A prepares a sensing requirement as a requirement for sensing. The sensing requirement includes at least one of the type of sensing, the sensing target range, the precision of sensing, the response time of sensing, for example. The type of sensing is a requirement about what sensing data are needed or sensing data from what sensor are needed, for example. The sensing target range is a requirement about sensing data for what geographical range are needed. The precision of sensing is a requirement about how precisely sensing can be performed. The precision of sensing according to the present disclosure includes at least one of repeatability or measurement variation, accuracy or closeness to the true value, resolution (resolution in space, time, frequency, energy, etc.), and dynamic range. The response time of sensing is a requirement about the time required to return a sensing result since a sensing request is received. The requirements mentioned here are merely exemplary, and the sensing requirement may include other requirements.

In a certain embodiment, the UE-A determines to acquire sensing data for a predetermined range, and prepares a sensing requirement for the predetermined range. The predetermined range may be a range for which the UE-A cannot perform sensing itself, for example. By way of example, when the UE-A is a vehicle, the sensing target range (predetermined range) may be a range outside the view of the UE-A, a range to which the UE-A is expected to move, etc. The sensing requirement may include not only a range but also information as to how long sensing data should be acquired for.

In step 22, the UE-A sends an inquiry about the sensing requirement to the SENSING 11m via the RAN-A. In the present embodiment, the inquiry about the sensing requirement is to make a notification of the sensing requirement and request a reply that indicates UEs capable of sensing that meets the sensing requirement. The inquiry about the sensing requirement may also be referred to as an inquiry about UEs that meet the sensing requirement or a UE inquiry.

In step 23, the SENSING 11m searches for a UE with a sensing capability that meets the sensing requirement in the inquiry with reference to the sensing capability stored in the storage device in response to receiving the sensing requirement from the UE-A. The “UE with a sensing capability that meets the sensing requirement in the inquiry” can be expressed as a UE capable of sensing that meets the sensing requirement in the inquiry. In the present disclosure, the “UE with a sensing capability that meets the sensing requirement in the inquiry” is also expressed as a “UE that meets the sensing requirement in the inquiry”. When there is a plurality of UEs that meets the sensing requirement, the SENSING 11m extracts at least one of such UEs. When the sensing requirement is met by combining the sensing results from a plurality of UEs, the combination of the UEs corresponds to a UE that meets the sensing requirement. By way of example, when sensing for a certain range is requested, and when a certain UE is capable of sensing for a part of the range and another UE is capable of sensing for the rest of the range, the combination of the two UEs is extracted as a UE that meets the sensing requirement. Here, it is assumed that the UE-B is extracted as a UE that meets the sensing requirement from the UE-A. When there is no UE that meets the sensing requirement, the SENSING 11m notifies the UE-A of that, and ends the process.

In step 24, the SENSING 11m notifies the UE-A that the UE-B meets the sensing requirement. This notification may be any information that can identify the UE-B, e.g. international mobile subscriber identity (IMSI), subscription permanent identifier (SUPI), subscription concealed identifier (SUCI), 5G-global unique temporary identifier (5G-GUTI), international mobile equipment identifier (IMEI), and international mobile station equipment identity software version (IMEISV). In step 24, the SENSING 11m may notify the UE-A of information about the sensing capability of the UE-B, in addition to the information that can identify the UE-B.

When there is a plurality of UEs that matches the sensing requirement, the SENSING 11m stores, in the notification, at least one of the UEs that match the sensing requirement. When the sensing requirement is met by sensing by a plurality of UEs, the SENSING 11m stores, in the notification, an indication that the sensing requirement is met by sensing by the UEs.

In step 25, the UE-A determines a UE (UE-B in the current example) to be requested for proxy sensing based on the notification from the SENSING 11m, and transmits a sensing proxy request to the SENSING 11m via the RAN-A. The sensing proxy request may include an identifier of the UE (UE-B in the current example) to be requested and the sensing requirement, for example. The sensing requirement in step 22 and the sensing requirement in step 25 may be the same as or different from each other. For example, the UE-A may use a subset of the sensing capability of the UE-B indicated from the SENSING 11m in step 24 as the sensing requirement in step 25. The sensing proxy request may also be referred to as a sensing data acquisition request, a sensing data transmission request, a measurement request, etc.

In step 26, the SENSING 11m transmits a sensing request to the UE (UE-B in the current example) included in the sensing proxy request from the UE-A. The sensing request includes information corresponding to the sensing requirement included in the sensing proxy request from the UE-A.

In step 27, the UE-B makes a determination about execution of sensing in response to the sensing request from the SENSING 11m. In the present embodiment, the UE-B selects one of three options, that is, to execute (accept), refuse, and withhold sensing. There may be two options, that is, to execute (accept) and refuse sensing, with no option to withhold sensing.

Steps 28 to 32 constitute a process for a case where the UE-B accepts the sensing request.

In step 28, the UE-B sends a notification that the sensing request is accepted to the SENSING 11m via the RAN-B. This notification may also be referred to as a sensing request confirmation. When the UE-B accepts the sensing request, a sensing session based on the sensing request is started. This sensing session may also be referred to as a proxy sensing session or a cooperative sensing session.

In step 29, the UE-B performs sensing using a sensor under a condition that conforms to the sensing requirement included in the sensing request. In step 30, the UE-B transmits sensing data to the SENSING 11m via the RAN-B as a response to the sensing request. The sensing data to be transmitted may be or may not be subjected to processing, as long as the data are based on the output result from the sensor. The sensing data to be transmitted may also be referred to as a sensing measurement result. In step 31, the SENSING 11m converts the format of the sensing data as necessary. In step 32, the SENSING 11m transmits the sensing data after the format conversion to the UE-A as the origin of transmission of the sensing proxy request.

Steps 33 and 34 constitute a process for a case where the UE-B refuses the sensing request. In step 33, the UE-B sends a notification that the sensing request is refused to the SENSING 11m via the RAN-B. In step 34, the SENSING 11m sends a notification that the sensing proxy request is refused to the UE-A via the RAN-A.

Steps 35 to 41 constitute a process for a case where the UE-B withholds the sensing request. In step 35, the UE-B sends a notification that the sensing request is withheld to the SENSING 11m via the RAN-B. The option to withhold sensing is selected when sensing cannot be or is not executed at present but sensing will be executed later, for example. When the sensing request is to be withheld, the UE-B starts a sensing session based on the sensing request. In step 36, the SENSING 11m sends a notification that the sensing proxy request is withheld to the UE-A via the RAN-A. In step 37, the UE-B stands by until the timing to execute sensing, e.g. the timing when the sensor becomes available for use. The processes in steps 38 to 41 are the same as the processes in steps 29 to 32, respectively, and thus will not be described.

The operation example described above is merely exemplary, and may be modified as appropriate.

In the operation example described above, for example, the SENSING 11m notifies the UE-A of a UE that matches the sensing requirement, and then the UE-A determines an entity requested for proxy sensing (steps 24 and 25). However, this procedure may be omitted, and the SENSING 11m may transmit a sensing request to at least one of the UEs (second user terminal) extracted in step 23 without checking with the UE-A (first user terminal).

The UE-A may determine whether a proxy sensing request for the UE-B is continued after the UE-B withholds the sensing request (steps 35 and 36), and the UE-B may perform sensing only when the proxy sensing request is continued.

### Operation Example: Sensing Data Format Conversion

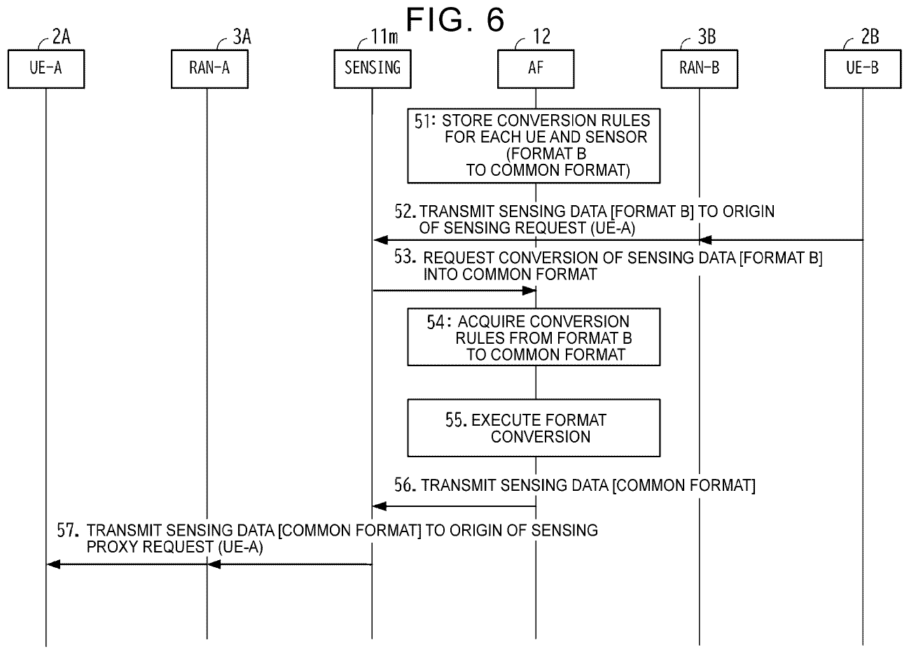

FIG. 6 is a sequence diagram illustrating a sensing data format conversion process (step 31 in FIG. 5B). While the format conversion process is described here as being executed by the AF 12 (format conversion device), the format conversion process may be executed by the SENSING 11m or another NF, for example.

In step 51, the AF 12 sets and stores rules for converting the format of sensing data for each UE or sensor. Here, it is assumed that the UE-B or a sensor of the UE-B outputs sensing data in a format B, and the AF 12 stores rules for converting the format from the format B to a common format.

In step 52, the UE-B transmits the sensing data in the format B as a response to the sensing request from the SENSING 11m. The process in step 52 corresponds to the processes in step 30 in FIG. 5B and step 39 in FIG. 5C. In step 53, the SENSING 11m transmits a request to convert the sensing data received from the UE-B to the AF 12. The conversion request includes the sensing data received from the UE-B and information that enables grasping the format of the sensing data, for example.

In step 54, the AF 12 acquires conversion rules for converting the received sensing data into the common format, that is, rules for conversion from the format B into the common format, from the storage device. In step 55, the AF 12 converts the received sensing data into the common format according to the acquired conversion rules. In step 56, the AF 12 transmits the sensing data converted into the common format to the SENSING 11m. In step 57, the SENSING 11m transmits the sensing data in the common format to the UE-A. Step 57 corresponds to the processes in step 32 in FIG. 5B and step 41 in FIG. 5C.

### Advantageous Effect of Present Embodiment

According to the present embodiment, each UE notifies the SENSING 11m of its sensing capability, and therefore the SENSING 11m can immediately determine, based on a sensing requirement received from a certain UE, an appropriate UE that matches the requirement. It is only necessary that the UE that requests proxy sensing should indicate the sensing requirement to the SENSING 11m, and it is not necessary for the UE itself to select a UE to be requested for proxy sensing. Thus, the UE can request proxy sensing through a simple procedure.

### Second Embodiment

In the present embodiment, as illustrated in FIG. 1A, user terminals (e.g. vehicles) directly communicate with each other.

In the present embodiment, the UEs may communicate with each other using any standard. While examples of the communication standard that can be employed include 5G-Sidelink (SL), Wi-Fi Direct, and Bluetooth, these are not limiting.

The configuration of each UE is the same as the configuration (FIG. 3B) of the UE according to the first embodiment, and therefore will not be repeatedly described.

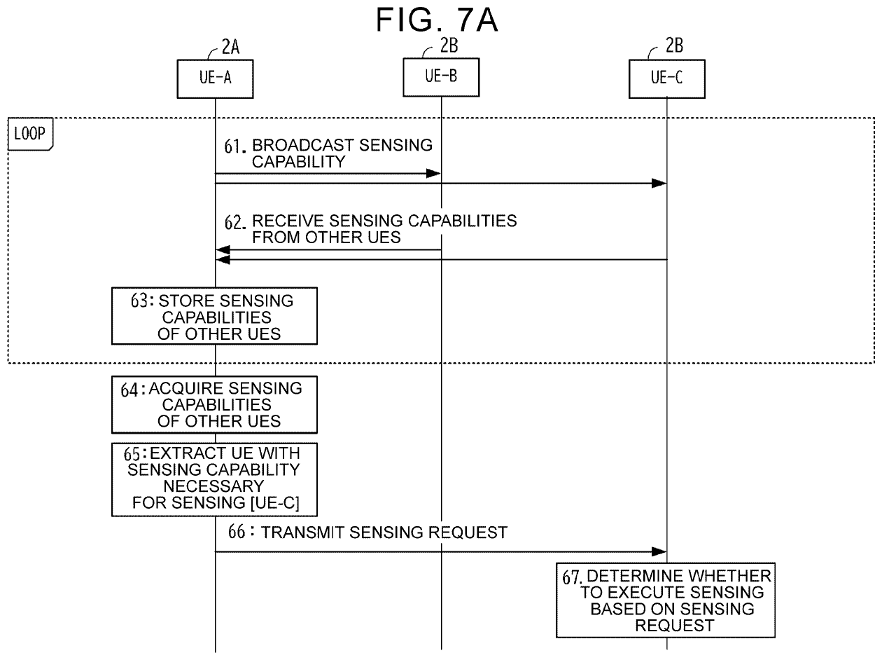

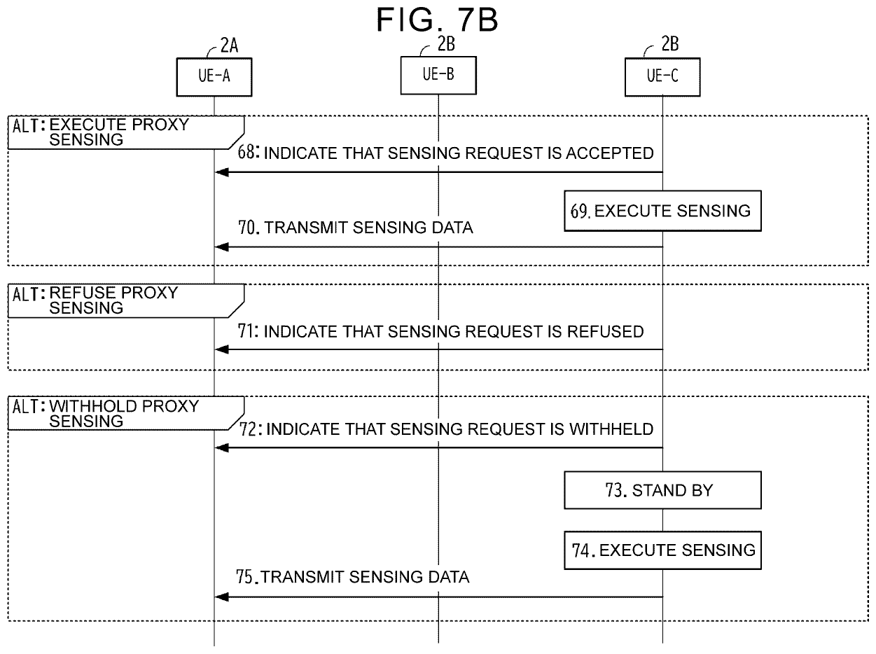

FIGS. 7A and 7B are each a sequence diagram illustrating a sensing capability notification process and a cooperative sensing process according to the present embodiment. While three UEs 2, namely a UE-A (2A), a UE-B (2B), and a UE-C(2C), are used in the description here, the number of UEs 2 is not limited. In the present example, the UE-A can be considered as an example of a “first user terminal” according to the present disclosure, and the UE-C can be considered as an example of a “second user terminal”.

Steps 61 to 63 correspond to a process of exchanging the sensing capabilities among the UEs. In step 61, the UE-A broadcasts the sensing capability of the UE-A to UEs in the surroundings. The sensing capability of the UE-A is received and stored by the UE-B and the UE-C.

In step 62, the UE-A receives the sensing capabilities broadcast from the UE-B and the UE-C. In step 63, the UE-A stores the received sensing capabilities of the UE-B and the UE-C in the storage device.

The processes in steps 61 to 63 are repeatedly executed regularly. The order of these processes is not limited to the order in the above description.

The processes in steps 64 to 75 correspond to processes for proxy sensing (cooperative sensing) based on the request from the UE-A. It is assumed that the UE-A has determined to perform sensing according to a predetermined requirement prior to step 64.

In step 64, the UE-A acquires the sensing capabilities of the other UEs stored in the storage device. In step 65, the UE-A extracts UEs with sensing capabilities that match the sensing requirement with reference to the sensing capabilities of the UEs. Here, it is assumed that the UE-C matches the sensing requirement and has been determined as an entity requested for proxy sensing.

In step 66, the UE-A transmits a sensing request to the UE-C. This sensing request includes a sensing requirement desired by the UE-A.

In step 67, the UE-C makes a determination about execution of sensing based on the received sensing request. In the present embodiment, the UE-C selects one of three options, that is, to execute (accept), refuse, and withhold sensing. There may be two options, that is, to execute (accept) and refuse sensing, with no option to withhold sensing.

Steps 68 to 70 constitute a process for a case where the UE-C accepts the sensing request. In step 68, the UE-C sends a notification that the sensing request is accepted to the UE-A. In step 69, the UE-C performs sensing using a sensor under a condition that conforms to the sensing requirement included in the sensing request. In step 70, the UE-C transmits sensing data to the UE-A as a response to the sensing request.

Step 71 constitutes a process for a case where the UE-C refuses the sensing request, and the UE-C notifies the UE-A that the sensing request is refused.

Steps 72 to 75 constitute a process for a case where the UE-C withholds the sensing request. In step 72, the UE-C notifies the UE-A that the sensing request is withheld. The option to withhold sensing is selected when sensing cannot be or is not executed at present but sensing will be executed after the lapse of time, for example. In step 73, the UE-C stands by until the timing to execute sensing, e.g. the timing when the sensor becomes available for use. The processes in steps 74 and 75 are the same as the processes in steps 69 and 70, respectively, and thus will not be described.

According to the present embodiment, each UE broadcasts its sensing capability to UEs in the surroundings, and therefore can immediately determine, based on a sensing requirement desired by the UE itself, an appropriate UE that matches the requirement.

### Other Modifications

The above embodiments are merely exemplary, and the present disclosure may be modified as appropriate without departing from the gist of the present disclosure. For example, in the second embodiment, the UE-A transmits a sensing request to the UE-C, and the UE-C transmits sensing data to the UE-A as a response to the sensing request. However, the UE-A may receive a sensing request from the UE-C, and the UE-A may transmit sensing data to the UE-C as a response to the sensing request, in addition to the process performed in the second embodiment. In the second embodiment, for example, the UE-C selects one of three options, that is, to execute (accept), refuse, and withhold sensing, in response to a sensing request from the UE-A, and transmits a notification that the sensing is executed (accepted), refused, or withheld to the UE-A. However, the UE-C may make a sensing request, and the UE-A may select one of three options, that is, to execute (accept), refuse, and withhold sensing, in response to the sensing request from the UE-C, and transmit a notification that the sensing is executed (accepted), refused, or withheld to the UE-C.

The present disclosure can also be implemented by supplying a computer with a computer program that implements the functions described in relation to the above embodiments and causing one or more processors of the computer to read and execute the program. Such a computer program may be provided to the computer using a non-transitory computer-readable storage medium that is connectable to a system bus of the computer, or may be provided to the computer via a network. Examples of the non-transitory computer-readable storage medium include any type of disk such as a magnetic disk (such as a floppy (registered trademark) disk and a hard disk drive (HDD)) and an optical disk (such as a Compact Disc Read Only Memory (CD-ROM), a Digital Versatile Disc (DVD), and a Blu-ray Disc), a read only memory (ROM), a random access memory (RAM), an erasable programmable read only memory (EPROM), an EEPROM, a magnetic card, a flash memory, an optical card, and any type of medium that is suitable to store electronic instructions.

What is claimed is:

1. A network node that constitutes a wireless communication network, comprising one or more processors configured to:
receive a sensing configuration parameter for each user terminal from a plurality of user terminals;
receive a sensing requirement from a first user terminal; and
transmit information about a second user terminal with the sensing configuration parameter that matches the sensing requirement to the first user terminal.

2. The network node according to claim 1, wherein the sensing configuration parameter is a parameter associated with a sensing capability of the user terminal.

3. The network node according to claim 2, wherein the sensing configuration parameter includes at least one of a frequency band to be used for sensing, a type of sensing, a position of the user terminal, a moving speed of the user terminal, a sensing target range, a precision of sensing, and a response time of sensing.

4. The network node according to claim 1, wherein the sensing requirement includes at least one of a type of sensing, a sensing target range, a precision of sensing, and a response time of sensing.

5. The network node according to claim 1, wherein the one or more processors are further configured to:
receive a measurement request for the second user terminal from the first user terminal;
transmit a sensing request to the second user terminal;
receive a sensing measurement result from the second user terminal; and
transmit the sensing measurement result to the first user terminal.

6. The network node according to claim 5, wherein the one or more processors are configured to transmit the sensing measurement result received from the second user terminal to the first user terminal after converting a format of the sensing measurement result based on information associated with a data format of the sensing measurement result from the second user terminal.

7. The network node according to claim 6, wherein:
the information associated with the data format of the sensing measurement result from the second user terminal is information to be used to convert the sensing measurement result from the second user terminal into a predetermined data format; and
the sensing measurement result transmitted to the first user terminal is expressed in the predetermined data format.

8. The network node according to claim 1, wherein the one or more processors are further configured to:
receive a measurement request for the second user terminal from the first user terminal;
transmit a sensing request to the second user terminal; and
receive a notification that the sensing request is accepted, refused, or withheld from the second user terminal.

9. A wireless communication system comprising:
a first user terminal;
a second user terminal; and
a network node, wherein:
the second user terminal is configured to transmit a sensing configuration parameter to the network node;
the network node is configured to receive the sensing configuration parameter from the second user terminal;
the first user terminal is configured to transmit a sensing requirement to the network node;
the network node is configured to receive the sensing requirement from the first user terminal; and
the network node is configured to transmit information about the second user terminal to the first user terminal, or transmit a sensing request to the second user terminal, when the second user terminal includes the sensing configuration parameter that matches the sensing requirement.

10. A user terminal comprising:
a sensor; and
one or more processors, wherein:
the user terminal is a first user terminal; and
the one or more processors are configured to
broadcast a sensing configuration parameter for the sensor,
receive the sensing configuration parameter from a second user terminal,
transmit a sensing request to the second user terminal, and
receive a sensing measurement result based on the sensing request from the second user terminal.

11. The user terminal according to claim 10, wherein the sensing configuration parameter is a parameter associated with a sensing capability of the sensor.

12. The user terminal according to claim 11, wherein the sensing configuration parameter includes at least one of a frequency band to be used for sensing, a type of sensing, a position of a user terminal, a moving speed of a user terminal, a sensing target range, a precision of sensing, and a response time of sensing.

13. The user terminal according to claim 10, wherein the one or more processors are further configured to:
receive the sensing request from the second user terminal; and
transmit the sensing measurement result based on the sensing request to the second user terminal.

14. The user terminal according to claim 13, wherein the one or more processors are configured to transmit a notification that the sensing request is accepted, refused, or withheld to the second user terminal in response to receiving the sensing request from the second user terminal.
